(19) United States
(12) Patent Application Publication
(10) Pub. No.: US 2016/0363167 A1
(43) Pub. Date: Dec. 15, 2016

(54) STEEL COMPOSITION FOR FLASH-BUTT WELDING

(71) Applicant: Staffan Larsson, Goteborg (SE)

(72) Inventor: Staffan Larsson, Goteborg (SE)

(73) Assignee: Aktiebolaget SKF, Goteborg (SE)

(21) Appl. No.: 15/171,522

(22) Filed: Jun. 2, 2016

(30) Foreign Application Priority Data
Jun. 10, 2015 (SE) 1550777-5

(51) Int. Cl. F16C 33/62; C22C 38/44; C22C 38/42; C22C 38/06; B23K 11/04; C22C 38/02; C22C 38/00; C22C 38/60; C22C 38/46; C21D 9/40; C22C 38/50; C22C 38/04

(52) U.S. Cl. CPC F16C 33/62; C22C 38/50; C22C 38/44; C22C 38/42; C22C 38/06; C22C 38/04; C22C 38/02; C22C 38/002; C22C 38/001; C22C 38/008; C22C 38/60; C22C 38/46; C21D 9/40; B23K 11/04; F16C 2204/66; F16C 2204/72

(57) ABSTRACT

A bearing steel composition having the following composition in weight-%; 0.89-0.95 C, 0.18-0.26 Si, 0.5-0.8 Mn, 1.65-1.95 Cr, 0.2-0.25 Ni, 0.45-0.6 Mo, 0.1-0.3 Cu, 0.001-0.0025 S, and at least one of the following elements: 0-0.018 P, 0.001-0.003 Ca, 0.02-0.05 Al, 0-0.0010 0, 0-0.04 As, 0-0.002 Pb, 0-0.003 Ti, 0.005-0.015

N, 0-0.00015 H, 0-0.03 V, 0-0.075 Sn, 0-0.075 As+Sn+Sb, and a balance Fe, together with unavoidable impurities.

### CROSS-REFERENCE TO RELATED APPLICATIONS

This application claims priority to Swedish patent application no. 1550777-5 filed on Jun. 10, 2015, the contents of which are fully incorporated herein by reference.

### TECHNICAL FIELD

This disclosure pertains to the field of steel and bearings. More specifically, this disclosure pertains to a novel bearing steel composition and a method of forming a bearing component comprising the novel steel composition.

### BACKGROUND OF THE INVENTION

Bearings are devices that permit constrained relative motion between two parts. Rolling bearings may provide inner and outer raceways and a plurality of rolling elements disposed therebetween. For long-term reliability and performance it is important that the various elements have high resistance to rolling contact fatigue, wear and creep.

The strength of steel is a very important mechanical property when selecting steel for a bearing application, as it has great significance for the durability of bearings. The life span of roller bearings is directly impacted by the durability of the bearing. Therefore, the strength properties have a direct impact on the life span of the bearings and are crucial for the safety and security. To obtain a high and uniform hardness level throughout a bearing component, and thus a long durability of the bearings, through-hardening is often performed, whereby a steel is heated to a temperature above its critical transformation temperature and cooled rapidly, usually by quenching in a quenching medium.

Modern steels are made with varying combinations of iron and alloying elements depending on the desired application of the steel product. Carbon, Silicon, Chromium, and Molybdenum are common alloying elements and are used for strengthening effect, improved hardenability. Through-hardening is used on high-carbon steel, such as steels having a carbon content of at least 0.85 weight-%, or above 1.0 weight-%. When the amount of carbon is too low through-hardening results in insufficient bearing surface hardness yielding indents and too low bearing life.

When manufacturing bearing components, the steel is often delivered from the steel mills in the form of steel plates, rods and tubes as input material, these components are during production both heated to high temperatures, such as during welding, hot rolling and forging. The components are also shaped at temperatures below the steel's recrystallization temperature, usually at ambient temperatures, which process is known as cold working or cold forming. During cold forming of the steel the hardness should not be too high in order to avoid the risk of crack formation.

Flash-butt welding, or “flash welding” is a resistance welding technique for joining metal parts, such as a steel components, in which the parts are aligned end to end and an electrical current is applied, producing an electric arc that melts and welds the ends of the parts, yielding an exceptionally strong and smooth joint. Although flash butt welding is a simple and efficient welding technique, the physical properties of a component in the vicinity of its weld joint(s) may be adversely affected by the flash butt welding, because of defects, such as weld/quench cracks, which occur during and after the flash butt welding, and since the microstructure of the steel in a heat affected zone (HAZ) around a weld joint will be modified by the flash butt welding and subsequently difficult to cold form.

### SUMMARY OF THE INVENTION

An object of the present disclosure is to provide an improved bearing steel composition having enhanced cold forming properties, also after flash butt welding, while maintaining a high strength throughout the entire steel component and thus a high durability.

As such, the present disclosure relates to a bearing steel composition for flash-butt welded bearing components comprising the following composition in weight-%;

C 0.89-0.95

Si 0.18-0.26

Mn 0.5-0.8

Cr 1.65-1.95

Ni 0.2-0.25

Mo 0.45-0.6

Cu 0.1-0.3

S 0.001-0.0025

and optionally one or more of the following elements

P 0-0.018

Ca 0.001-0.003

Al 0.02-0.05

O 0-0.0010

As 0-0.04

Pb 0-0.002

Ti 0-0.003

N 0.005-0.015

H 0-0.00015

V 0-0.03

Sn 0-0.075

where As+Sn+Sb 0-0.075

balance Fe, together with unavoidable impurities.

Optionally, the bearing steel composition may provide from 0.9 wt % C, such as from 0.91 wt % C, and optionally up to 0.94 wt % C. It has been found that in combination with the other alloying elements, the resulting steel composition provides enhanced cold forming properties and weldability to a bearing steel component manufactured from the steel composition, while still allowing the bearing steel component to be through-hardened and ensuring a high strength and durability.

Optionally, the bearing steel composition may provide from 0.2 to 0.25 wt % Si. It has been found that in combination with the other alloying elements, this relatively low Si content results in enhanced cold forming properties and weldability in a bearing steel component manufactured from the steel composition, inter alia by reducing the yield point of ferrite lamellae during restoring annealing treatment, after for example welding, and thus improving the ductility, while still allowing the bearing steel component to be through-hardened and ensuring a high strength and durability.

Optionally, the bearing steel composition may provide from 0.6 to 0.7 wt % Mn.

Optionally, the bearing steel composition may provide from 1.75 to 1.85 wt % Cr.

Optionally, the bearing steel composition may provide from 0.47 to 0.5 wt % Mo.

In combination with the other alloying elements, the amount of Manganese, Chromium and Molybdenum improves the cold forming properties by ensuring a sufficiently low carbide formation. It has been found that when keeping the carbide formation at a relatively low level, such as around about 13.5 to around 14 wt-% herein, and below 15 wt-%, this contributes to arriving at improved cold forming and weldability properties for a bearing steel component manufactured from the steel composition according to the present disclosure.

It has surprisingly been found that a bearing steel component manufactured from the steel composition according to the present disclosure exhibits excellent cold forming properties, even after flash butt welding, while fulfilling the prerequisite for performing a through-hardening process and thus ensuring a long durability of the bearing steel component. By balancing the carbon content and the amounts of Chromium and Molybdenum according to the present disclosure the formation of carbides during heating is kept on a sufficiently low level to ensure the mechanical properties desired for bearing components and the possibility to through-harden them while keeping the hardness of the steel as low as possible for improved cold forming properties.

Optionally, a bearing component is formed from the steel bearing composition and optionally the bearing component is at least part of a bearing ring.

Optionally, the bearing component has a flash butt weld joint. Flash butt welding exerts a high stress on the material in the heat affected zone and the steel composition according to the present disclosure is especially adapted to withstand the conditions during the flash-butt welding and to be subjected to a restoring annealing treatment after welding.

The present disclosure also relates to a method for manufacturing a bearing steel component having a flash butt weld joint comprising the steps of: (i) providing a bearing steel composition according to any aspect of this disclosure, (ii) forming at least a part of a bearing component from the steel bearing composition; and (iii) flash butt welding a joint by flashing and upsetting the weld.

### BRIEF DESCRIPTION OF THE DRAWINGS

Preferred embodiments and beneficial effects of the present invention are described in detail below with reference to the accompanying drawings.

FIG. 1 is a bearing assembly manufactured from a steel composition according to the present invention; and

FIG. 2 is a bearing steel component having a welded joint, such as a flash butt welded joint that is manufactured using a method according to the present invention.

### DETAILED DESCRIPTION

The bearing composition according to the present disclosure is intended for manufacturing of any type of bearing component, such as a bearing ring or a part of a bearing ring, for use in a bearing such as a roller bearing, a needle bearing, a tapered roller bearing, a spherical roller bearing, a toroidal roller bearing, a thrust bearing or a bearing for any application in which it is subjected to alternating Hertzian stresses, such as rolling contact or combined rolling and sliding. The bearing may for example be used in automotive, wind, marine, metal producing or other machine applications which require high wear resistance and/or increased fatigue and tensile strength.

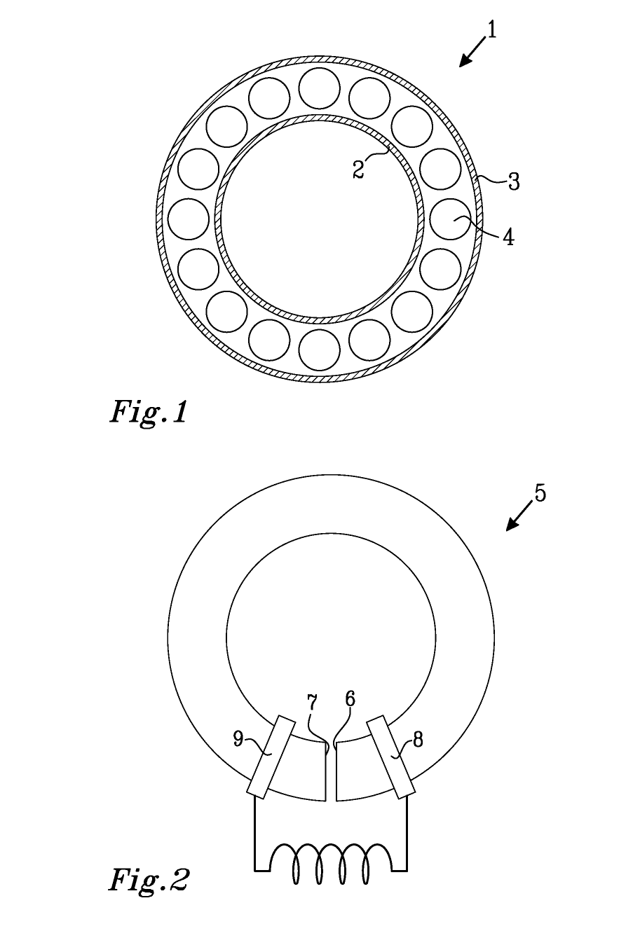

FIG. 1 shows an example of a bearing 1, namely a rolling element bearing that may range in size from 10 mm diameter to a few metres diameter and have a load-carrying capacity from a few tens of grams to many thousands of tonnes. The bearing 1 according to the present invention may namely be of any size and have any load-carrying capacity. The bearing 1 has an inner ring 2 and an outer ring 3, one or both which may constituted by a ring according to the present invention, and a set of roller elements 4. The inner ring 2, the outer ring 3 and/or the rolling elements 4 of the rolling element bearing 1, and preferably all of the rolling contact parts may be manufactured from a steel composition according to the present disclosure.

The present disclosure also concerns a bearing steel component comprising a welding joint, such as a flash butt welded joint, which is manufactured using a method according to any of the aspects of the disclosure. FIG. 2 shows flash butt welding of an open ring 5, the ring is clamped near the ends 6,7 that are to be welded, using two clamping electrodes 8,9, and the ends 6,7 are then brought together until they meet, making light contact, and form a flash butt welding joint. While the ring in general is heated to about 200° C. during welding, the heat formed at the welding joint, between the clamps, is about 1300 to about 1500° C. The microstructure of the resulting steel ring 2,3 in the area of the weld joint, the heat affected zone (HAZ), is thus affected and the properties of the steel component in the HAZ are deteriorated. For a bearing ring 2, 3 the rolling contact fatigue properties of this zone are inadequate. The weldability of steels is to a high extent determined by the carbon content and is negatively influenced by the presence of carbon, due to the carbide formation resulting from the presence of carbon.

After welding, such as flash butt welding, the component and in particular the welding joint is commonly subjected to a restoration process involving annealing in order to restore the microstructure of the steel component at the site of the welding joint to arrive at a correct hardened microstructure and to ensure a proper wear resistance. It has been found that by using a steel composition comprising a Si content of from 0.18 to 0.26 weight-%, the yield point of ferrite lamellae will be sufficiently low during annealing to arrive at sufficiently ductile material for cold forming within bearing manufacturing. The expression “a sufficiently ductile material” is intended to mean a material which, when forming a steel plate having a thickness of 60 mm or less, is bendable and fulfils the specification in accordance with ISO 15614-13 part 13 “Upset (resistance butt) and flash weld” p. 4 table 1; test class A for bars/rods.

However, an aim of the present disclosure is also to balance the coexisting and competing requirements of the weldability and cold forming properties with the requirement of being able to subject the steel component to through-hardening, i.e. hardening the steel component uniformly throughout the component.

Through-hardening may be used on high-carbon steel, such as steels having a carbon content of at least 0.85 weight-%, or above 1.0 weight-%. This has conventionally been considered incompatible with the requirements of good weldability and cold forming properties. It has however surprisingly been found that a steel composition having a carbon content of from 0.89 to 0.95 weight-%, such as from 0.9 to 0.94 weight-% fulfills the requirement of the ability, for a steel component made of the steel composition, to be subjected to a through-hardening process while, in combination with the other alloying elements, also being suitable for welding, and which may be subjected to a subsequent restoring annealing and/or cold formed.

The expression “annealing” is intended to mean heat treatment that alters the microstructure of a material causing changes in its properties, such that strength, hardness and/or ductility.

It has been found that a steel composition, in combination with the other alloying elements described above, and having an alloy content of 0.5-0.8 weight-% Mn, 0.2-0.25 weight-% Ni, and 0.1-0.3 weight-% Cu when used for manufacturing bearing steel components results in a steel component being sufficiently ductile to cold form during bearing steel component manufacturing.

It has also been found that the amount of Cr and Mo are of importance for the steel composition and the resulting cold forming properties due to their function as carbide forming elements. By providing a composition having an amount of Cr from 1.65 to 1.95 weight-% and an amount of Mo from 0.45 to 0.6 weight-% a bearing steel component manufactured from the composition may be obtained which is sufficiently ductile to cold form during bearing component manufacturing. This is also relevant for Vanadium, so by furthermore providing a composition having from 0.01 to 0.03 weight-% V, the cold forming properties of a bearing steel component manufactured from the composition is additionally improved.

1. A bearing steel composition for flash-butt welded bearing components comprising the following composition in weight-%;
C 0.89-0.95
Si 0.18-0.26
Mn 0.5-0.8
Cr 1.65-1.95
Ni 0.2-0.25
Mo 0.45-0.6
Cu 0.1-0.3
S 0.001-0.0025
and at least one of the following elements
P 0-0.018
Ca 0.001-0.003
Al 0.02-0.05
O 0-0.0010
As 0-0.04
Pb 0-0.002
Ti 0-0.003
N 0.005-0.015
H 0-0.00015
V 0-0.03
Sn 0-0.075
wherein As+Sn+Sb 0-0.075
and a balance Fe, together with unavoidable impurities.

2. The bearing steel composition according to claim 1, further comprising from 0.9 wt % C.

3. The bearing steel composition according to claim 1, further comprising up to 0.94 wt % C.

4. The bearing steel composition according to claim 1, further comprising from 0.2 to 0.25 wt % Si.

5. The bearing steel composition according to claim 1, further comprising from 0.6 to 0.7 wt % Mn.

6. The bearing steel composition according to claim 1, further comprising from 1.75 to 1.85 wt % Cr.

7. The bearing steel composition according to claim 1, further comprising from 0.47 to 0.5 wt % Mo.

8. A bearing component formed from a composition of bearing steel in weight-%;
C 0.89-0.95
Si 0.18-0.26
Mn 0.5-0.8
Cr 1.65-1.95
Ni 0.2-0.25
Mo 0.45-0.6
Cu 0.1-0.3
S 0.001-0.0025
and at least one of the following elements
P 0-0.018
Ca 0.001-0.003
Al 0.02-0.05
O 0-0.0010
As 0-0.04
Pb 0-0,002
Ti 0-0.003
N 0.005-0.015
H 0-0.00015
V 0-0.03
Sn 0-0.075
wherein As+Sn+Sb 0-0.075
and a balance Fe, together with unavoidable impurities.

9. The bearing component according to claim 8, wherein the steel bearing component has a flash butt weld joint.

10. The bearing component according to claim 8, wherein the bearing component is a bearing ring.

11. A bearing steel composition used in a bearing component formed from a composition of bearing steel in weight-%;
C 0.89-0.95
Si 0.18-0.26
Mn 0.5-0.8
Cr 1.65-1.95
Ni 0.2-0.25
Mo 0.45-0.6
Cu 0.100.3
S 0.001-0.0025
and at least one of the following elements
P 0-0.018
Ca 0.001-0.003
Al 0.02-0.05
O 0-0.0010
As 0-0.04
Pb 0-0,002
Ti 0-0.003
N 0.005-0.015
H 0-0.00015
V 0-0.03
Sn 0-0.075
wherein As+Sn+Sb 0-0.075
and a balance Fe, together with unavoidable impurities, wherein
the bearing steel component is intended to be flash butt welded.

12. The bearing steel composition used in a bearing component formed from the composition of bearing steel according to claim 11, wherein the bearing steel component is a bearing ring.

13. A method for manufacturing a bearing steel component having a flash butt weld joint, the method comprising:
(i) providing a bearing steel composition as defined in claim 1;
(ii) forming at least a part of a bearing component from the steel bearing composition; and
(iii) flash butt welding a joint by flashing and upsetting the weld.

14. The method for manufacturing a bearing steel component according to claim 13, further comprising the step:
(iv) subjecting the at least said joint to an annealing treatment.
